(19) United States
(12) Patent Application Publication
(10) Pub. No.: US 2016/0106067 A1
(43) Pub. Date: Apr. 21, 2016

(54) Multi-Functional Telescopic Pet Ensemble

(71) Applicant: Donald Kevin Wedertz, San Mateo, CA (US)

(72) Inventor: Donald Kevin Wedertz, San Mateo, CA (US)

(21) Appl. No.: 14/121,779

(22) Filed: Oct. 16, 2014

(51) Int. Cl. A01K 15/02; A01K 1/035

(52) U.S. Cl. CPC A01K 15/024; A01K 1/035

(57) ABSTRACT

This multi-functioning, telescopic, pet ensemble purposes a foundational enclosure for positioning one; and multiple, annular devices into vertical pillars, with a simple twist. The first device can house a second device within its' core and support a flat embodiment, near its upper end. The second device can be telescoped to incremental elevations, that achieve full extension and its' surface can support one; and multiple, modular-hinged, open-channel collars that can receive a flat embodiment in each respective collar; for static positions, and be swiveled in 360° degrees. This invention can be covered with any type of replaceable fibrous materials so ferals, domestic feline(s) and other small pets will use this invention repeatedly for resting, playing, eating and exercising on, instead of unintentionally destroying valuable padded home furnishings and scratching finished surfaces. Assembly is quick, without hand-tools. The ensemble is light-weight, very sturdy, carries easily and is eco-friendly.

### BRIEF DESCRIPTION OF DRAWINGS

FIG. 1 Is a 3-point perspective, with a cut-a-away view into the primary annular and secondary annular members.

FIG. 2 Is a profile; cut-a-way view, inside the foundational enclosure.

FIG. 3 Is a profile view of the primary annular member with the secondary annular member, in a stowed position.

FIG. 4 Is a profile view of the primary annular member with the secondary annular member telescoped.

FIG. 5 Is a profile view of the modular ledge; aligned with the open channel area, atop the primary annular member, while the secondary annular member is telescoped up.

FIG. 6 Is a shortened; profile view, of the primary annular member with the secondary annular member telescoped, while the modular; hinged, opened-channel collar is positioned around the upper area.

FIG. 7 Is a shortened; profile view, of the primary annular member with the secondary annular member telescoped, while the modular; hinged, opened-channel collar is closed around the upper area.

FIG. 7a. Is a profile view of modular ledges in position; within both open-channel collars, on the primary and secondary annular members.

FIG. 8 Is a plan view of the rectangular shaped foundational enclosure with the primary annular member inserted thru the access portal and ready to be turned.

FIG. 9 Is a perspective view of the modular, hinged, open-channel collar is closed.

FIG. 10 Is a plan view of the modular, hinged, open-channel collar is fully open and its inside area is facing up.

FIG. 11 Is a plan view of the modular, hinged, open-channel collar is fully open and resting on a flat surface, as its flat horizontal surfaces are facing up.

### BACKGROUND OF INVENTION

This present invention is the most functional and versatile cat scratcher post for this millennium, without the limitations of earlier patented scratcher posts, wherein, their individual pieces aren't multi-functional and their vertical structures necessitated the need for adding pieces, to extend their heights. Earlier patented scratcher posts employed vertical embodiments placed one-atop-another, with smaller pieces conjoined between each vertical piece, for the purpose of holding a flat platform level with the ground. Such platform is used by a feline or small pet to rest on and use as a look-out vista. The smaller piece; supporting the platform, isn't easily removable by simply pulling it away from between the vertical embodiments.

Each vertical embodiment and a smaller piece; supporting a flat platform; above the smaller piece to be removed, must all be removed prior to reaching the actual smaller piece. After it is removed, each vertical embodiment and the smaller piece; in between, must be reassembled; atop each other, one at a time. Though, removing and changing-out parts may appear trivial, it does become quite bothersome to the owner, anytime they choose to make adjustments to their patented scratcher post. Numerous cat scratcher devices have been patented and available in the market place that can be covered with replaceable carpet and other replaceable fibrous coverings to be clawed up, climbed up and stretched against. Their base's support singular and multiple vertical posts; of various shaped exteriors and diameters, having lengths of short, medium and long vertical embodiments that interconnect together; one-atop-the-other, beginning with a connection at the base, via an internal fastener.

Some vertical embodiments are single level, employing hardware to connect with the bottom base as a supportive means and connect with a toy-like apparatus; at its upper area, to attract a pet.

The aforementioned cat scratching inventions reveal the following commonalities: A base is connected to a single vertical embodiment with some type of hardware. When an invention employs multi-levels, after the base is connected; via hardware, to the first vertical embodiment, additional vertical embodiments are connected with common threaded rods, where individual discs; with center holes, are placed over the threaded rod, to hold individual embodiments together; end-to-end, to form the entire invention. Certain floor-to-ceiling inventions employ a spring-loaded hollow tube; at the top of the invention, to reach the ceiling. The ceiling compresses the spring-loaded tube downward; into the upper area of the invention, to hold the entire assembly in a vertical position while flooring surface aids with the vertical positioning.

Certain other patented scratcher inventions require placement near a wall for multiple brackets to be screwed in; at various vertical heights, to hold the scratcher post vertical segments in close proximity to the wall; to be safe, when feline(s) are using the invention. Modular platforms are attached to smaller embodiments; between vertical sections, where they are vertically positioned with dowel pins that provide attachment points. Some inventions employ two-sided brackets that surround the vertical embodiment and screws hold the two-sided bracket together prior to attaching another embodiment to the bracket.

Each aforementioned patented cat scratcher device that reaches various heights is somewhat cumbersome for the owner to assemble and a burden when changing any part of the invention. Many times the taller invention must lie flat on the floor to assemble, disassemble, and re-assemble.

According to what is known and patented, there is a need for a cat scratching device that is an embodiment of parts; where several parts, would provide multiple functions, wherein, a vertical embodiment hosts an inner member; as an integral device, that can be raised to any height, without employing same and similar looking pieces. Such similar pieces would need to be attached end-to-end, using some kind of hardware; within its core, to make the entire vertical structure strong. The vertical embodiment will also have an integral section; within its upper area, which can support a separate; flat planar device, that parallels the ground. This flat planar device provides multiple functions as being used a foundational support; for holding a cat condo or a different enclosure. When not being used as foundational support, it can be a resting surface for a cat or any pet that will fit; in a seated or prone position, on the surface.

This cat scratcher device will also have a modular device that can be manually opened and closed around the inner member; after it is raised to any elevation, from within the main vertical embodiment. Such modular device can hold a flat planar device, which can serve as another foundational support, to hold a cat condo. When not supporting a condo, it can be a resting surface for a cat and any pet that will fit on the surface. This present invention is the embodiment of parts that directly reflect the aforementioned functional usefulness of a part to be versatile. Such functionally versatile cat scratcher post will be green with the environment and become a mainstay in homes across the globe. And of course, this invention can be covered with any type of replaceable, fibrous material.

### SUMMARY

The direction this invention takes is to aggregate light-weight and sturdy horizontal and linear; annular, components to work in unison, therein demonstrating versatilities and cost effectiveness the owner can appreciate, that are unseen from other prior art assemblies which cater to ferals, domesticated felines and other small pets for various indoor and outdoor health and wellness routines.

Certain aspects; relating to computer manufacturing, cross over to facilitate ease-of-assembly for this invention, as one; of a multiple of, linear; annular, embodiments are inserted into a horizontal embodiment; for vertical arranging and vertical posturing. After arranging for vertical posturing is accomplished, a limited twisting motion ensures secured unions, then, other appendages can be placed onto the surfaces of one or multiple vertical embodiments. A minimum of manual dexterity and strength is required, without any hand-tool use. After assembly is completed, if any individual piece(s) are to be removed later, removal is done without having to un-assemble any other part of the ensemble.

From a commerce and e-commerce perspective on shipping this invention, shipping is hassle-free and it's light-weight saves the consumer on shipping costs, which can impact whether an order is approved or not. In-store displaying would require the same or less floor space as their current inventory requires for a similar category. Vertical space requirements would be similar to the height of a desk top. Horizontal rails would be handy for displaying individual components; of this invention, on hangers. A hard handle or slip handle can be added to any side surface of the horizontal component, as the bulk of this invention could be wrapped in a plastic sheeting, to keep the components close-together, for ease-of-transporting out of the store.

### PRIOR ART

* Cited by examiner

U.S. Pat. No. 2,005,817* A “Scratching Post” by Yoder, Daniel D. 06-1935 . . . U.S. Pat. No. 2,894,487* A Scratching Post With Renewable Fabric Cover by: Marvin, Goldson, 07-1959 . . . U.S. Pat. No. 2,997,019 * A Cats Claw Filing Post by Bryson, John H 08-1961 . . . U.S. Pat. No. 3,479,990 * A Cat Tree by Crow Frank L, 11-1969 . . . U.S. Pat. No. 3,479,991* An Animal Climbing Structure by Lichtenberger, William J. , 11-1969 . . . U.S. Pat. No. 3,595,209*. . . U.S. Pat. No. 4,177,763 A Cat scratching post assembly by Cook, Weldon R. House-hold Play and Exercise Post Assembly For Cats by Parker Paul A. 07 1971 . . . U.S. Pat. No. 5,144,911* A Component bed system for a pet by Moore, Cheri L. (Hurst, Tex.), Hall, Judy L. (Hurst, Tex.) . . . U.S. Pat. No. 5,176,105* A Fur grooming apparatus by Madden, Marc P., Livonia, Mich. (US). . .U.S. Pat. No. 5,517,945* A “Combined mechanically assisted animal amusement, grooming, and claw scratching device” by Udelle, Steven D. 05-1996 . . . U.S. Pat. No. 5,577,466* A Modular Play Structure For Animals by: Luxford, Pamela M., 11-1996 . . . U.S. Pat. No. 5,628,282* A “Mechanically Assisted Animal Self-Grooming Device” by Udelle Steven D. 05-1997 . . . U.S. Pat. No. 5,680,831* A Combined Mechanically Assisted Animal Exercise, Amusement, Self Grooming, and Claw Scratching Stimulator by Udelle, Steven D. 10-1997 . . . U.S. Pat. No. 5,713,306A Feline playground system by Johnson; Arnold B. (Levittown, N.Y.) . . . U.S. Pat. No. 5,875,735*A Modular Animal Perch Attached To Wall by Bradley et al. 03-1999 . . . U.S. Pat. No. 6,619,237* B2 Recoverable Cat Scratching Post by Robertson, Nita J. 09-2003 . . . US-2004/0194731* A1 Decorative Scratching Post by Lineberry, Christopher J. 10-2004 . . . U.S. Pat. No. 6,966,277* B2 Reconfigurable Modular Play And Exercise Structure For Animals by DeRaspe-Bolles et al. 12-2005 . . . US-2005/0263096* A1Pet Furniture System by Mita et al. 12-2005 . . . U.S. Pat. No. 7,171,922* B2 Cat Scratching Post by Lipscomb et al. 02-2007. . . U.S. Pat. No. 7,207,293* B2 Protective Cat Scratching Post by Deming, Jr., Robert F. 04-2007 . . . US-2008/0282987*A1 “Cat Tower With Separable Transportable Bed, Inset Corrugated Scratch Pad/Fabric Base, And Washable Woven Fabric Covers” By Ritchey, Sharon A. 11-2008 . . . U.S. Pat. No. 7,770,540* B2 Exercise And Perch System For Domestic Cats by Eric Lee Halpern—DesignWerks, Inc. 08-2010 . . . U.S. Pat. No. 7,867,143* B2 Climbing Tree by Jens Fenger-Eriksen 01-2011 . . . * Cited by examiner

All prior art, associated with the respective patent number are different from this preferred invention as follows: This inventions' annular device provides an integral; open channel area, at its upper most area. The open channel supports a modular ledge; in a horizontal plane, and as such, the modular ledge can be in a static position and be manually swiveled in 360° degrees. The modular ledge can also function as a horizontally supportive “bridge” between multiple annular devices that are adjacent to each other. The modular ledge can also function as a foundational support for any enclosure; such as a feline condo. The annular device also hosts a secondary annular device within its hollow core. When the owner wants to add some height to their invention; rather than physically implementing another section to its vertical structure, the owner simply grabs the inner handle and pulls the secondary annular device up to any elevation. The construction of the invention ensures the inner device is sturdy at any elevation, thus eliminating the need for any interior vertical hardware to reinforce vertical stability. This invention isn't designed to use the ceiling for vertical support or use intersecting corners; of a room, for vertical support and as such, this invention can stand alone within its foundational enclosure. The annular device(s) is held firm within its' respective access portal. Assembly takes mere seconds. Another versatile function of this invention is one such modular, hinged; open channel collar that works just like the integral open channel area on the primary annular device. Each hinged-collar can be manually placed on the secondary annular device; at any elevation, to hold a ledge, which can be used as a flat surface, be covered with any fibrous material and be a supportive foundation for a condo.

### REFERENCE NUMERALS IN DRAWINGS

1. Primary annular member
2. Secondary annular member
2a. Primary annular member shim
2b. Secondary annular member handle
3. Primary annular member; upper ring, of open channel area
3a. Arrows indicating open channel area
4. Coupler member; of open channel area
5. Vertical alignment eye bolt
5a. Nut and washer hardware on vertical alignment eye bolt
6. Head of anchor bolt
6a. Power grip area of anchor bolt
6b. Stop-catch area of anchor bolt
7. Key-way “v” notch
8. Top Plate of foundational enclosure
8b. Arrows indicating hollow area in foundational enclosure
9. Side plates forming foundational enclosure
10. Bottom plate of foundational enclosure

### 11. Nails

12. Modular ledge
12a. Two-pronged end of modular ledge
12b. Male fastener
12c. Pronged forks supported in open channel area atop primary member
12e. Pronged forks supported in open channel of modular hinged collar
13. Modular, hinged, open-channel collar
13a. Hinge of modular, hinged, open-channel collar
13b. Latch
13c. Latching Pin
13d. Upper surface of coupler; of modular hinged open channel collar
13e. Arrows indicating open-channel area of modular collar
14. Interior space between primary member and access portal

### DETAILED DESCRIPTION

This inventions' multi-functional, telescopic, pet ensemble is the integration of: A foundational semi-enclosure . . . a primary/first annular device . . . a second annular device . . . a modular-hinged, open-channeled device . . . a modular-flat planar device and replaceable fibrous materials for coverage. The assembly is completed without hand tools. The foundational enclosure can be named the foundational member, the enclosure, enclosure member, foundational model, and enclosure model. The enclosure can be placed on any level surface and hold primary annular device(s); with associated pieces, in an up-right manner.

### Materials for Enclosure

Materials can be thick plywood that are commonly available from home improvement and building supply stores. Other materials can be solid wood panels, narrow wood panels doweled and glued, aluminum plates, sheet metal sheets covering wood plates, poly resin plates or panes, any composite material or a combination of all such materials. Common hardware fasteners and non-toxic adhesives are also used.

### Tiered Levels

The foundational model can have a flat surface, spanning the top area while other foundation models can show a product line where: one (1) stepped-up elevation can begin; a certain distance from, the perimeter edge and span past the middle area to an ending edge, where the original level continues spanning to the opposite perimeter edge or the stepped-up elevation continues spanning to the opposite perimeter edge without stepping down. Other models can display two and multiple stepped-up elevations, with similar spans that duplicate the first stepped-up model. A profile view of all such elevations can depict their edges as being: squared off, rounded, beveled, and have more elaborate customizations. A plan view of such models can depict surfaces appearing to be: square, rectangular, triangular, hexagonal, oval, semi-oval, bi-lateral oval and any combination of shapes.

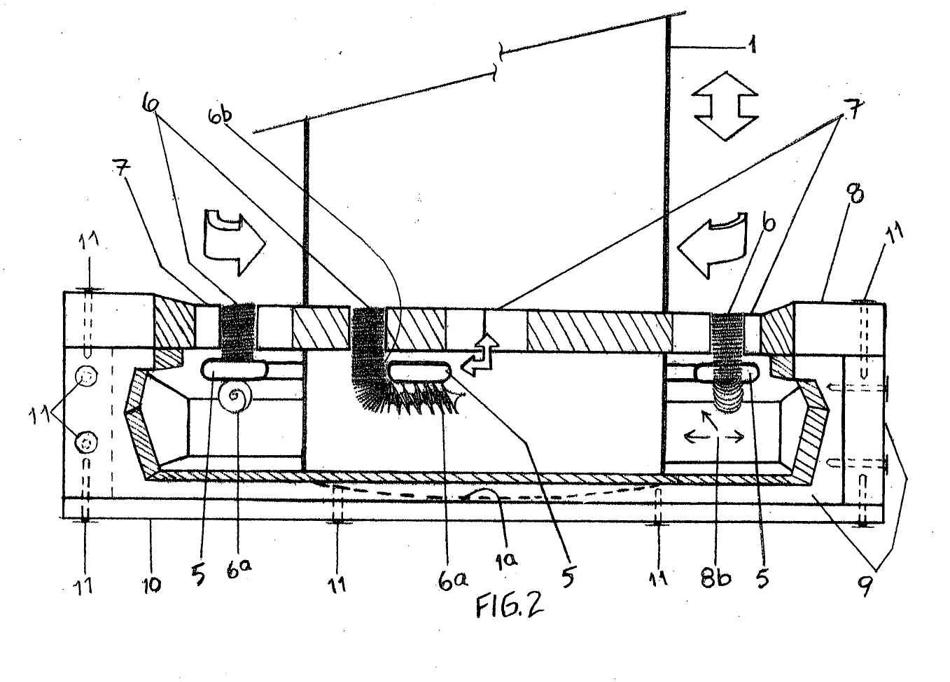

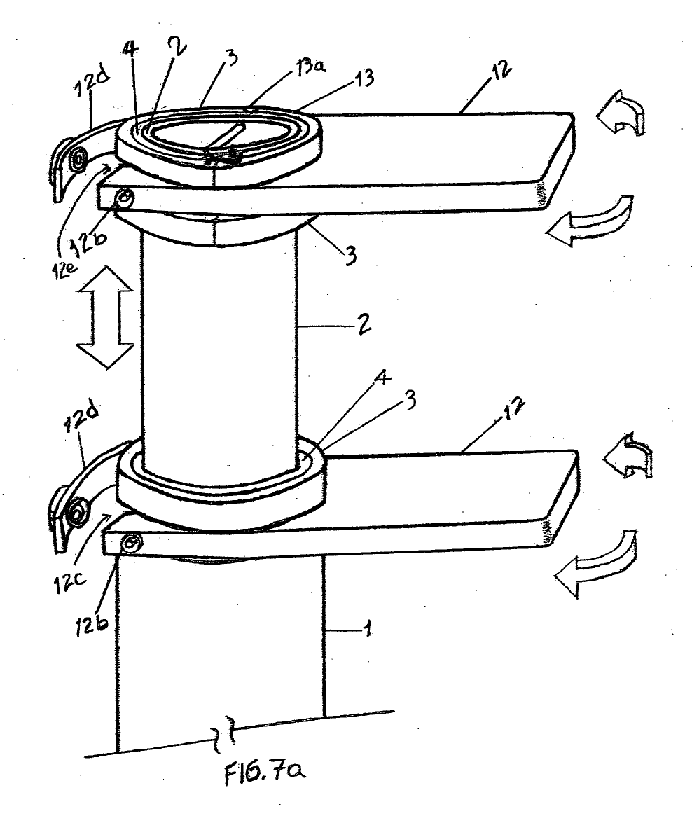

For the purpose of this writing, the foundational enclosure is depicted with a rectangular shape in FIG. 8, no. 8 and is a simple, single level; FIG. 2, rather than showing a stepped-up elevation. The enclosures' hollow chamber is acknowledged with arrows in FIG. 2, no. 8b. The enclosure's frame-work is shaped by placing four (4) lengths; called side plates, into a rectangular alignment, where one lengths' side surface, is at a 90° angle with; and perpendicular to, the inside side surface; near the end of, a second (2nd) adjoining length. This perpendicular positioning is called “end capping”. Two ends form a corner, where their outer surfaces are flush with each other. Their widths are equal to or slightly lesser; in thickness, as compared to the top plates' thickness.

Each corner can be tongue-and-groove and any method for adjoining two lengths together to form a corner. Side plates' vertical heights; FIG. 2, no. 9 dictate the inner chambers' depth; FIG. 2 no 8b. After all side plates are positioned, their ends are affixed together with finishing nails or other common hardware, similar to the nails; no. 11, used to conjoin the top plate to the side plates below it. Nails are placed in tandem positions, one above the other with a space between them; when conjoining side plate ends together. Non-toxic cementing adhesive bonds all surfaces together.

### Top Plate's Upper Surface

After the frame work is completed, the top plate; FIG. 2, no. 8, is placed over the frame and lined up, so its' perimeter edges are flush with the frame's outer edges. Nails or other common hardware fasten the top plate to the frame below. After the top plate is secured to the framework, it is flipped over so the bottom plate, seen at no. 10, can be affixed to the frame work the same way, to produce a hollow chamber. Non-toxic cementing adhesives bond all surfaces together. The top plate has an orifice; FIG. 8, no. 14a, in its middle area. The orifice is a passage way into the enclosures' hollow chamber and referred to as an access portal. The top plate can have multiple access portals; adjacent to each other, with a certain distance between portal edges, for maintaining the top plates' structural integrity.

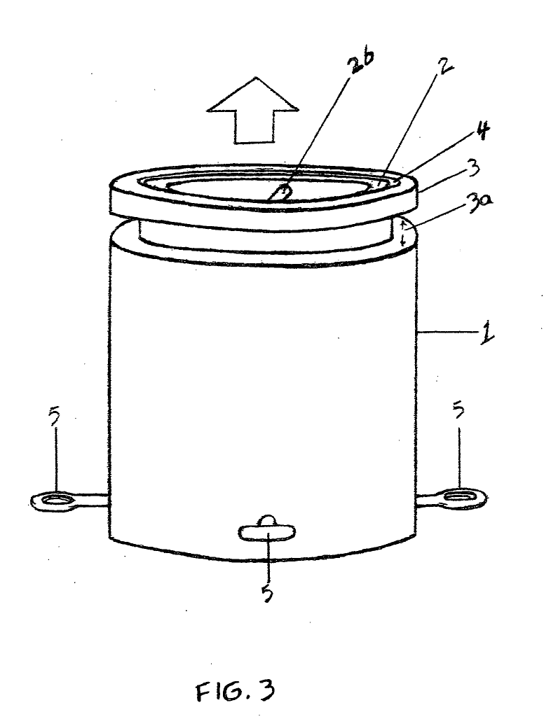

This distance prevents cracks from developing, when vertical embodiments begin to sway. A “V” is notched-out of the access portals' edge; FIG. 8, no. 7, every 90° degrees apart around the portals' edge. These notches are key-ways for the primary annular members' hardware; FIG. 3, no. 5, to pass through the top plate simultaneously as the bottom end; of the primary member, is inserted thru the access portal and into the hollow chamber. The key-ways can be a different shape to accommodate different shaped hardware.

### Top Plates' Bottom Surface

A small hole at FIG. 8, no. 6, is adjacent to; and to the right of, each key-way FIG. 8, no. 7. This hole goes completely through the top plate at FIG. 8, no. 14. and is a certain lateral distance from each key-way; FIG. 8, no. 7 and access portal; FIG. 8, no. 14a. An anchor bolt; FIG. 2 no. 6, is screwed through the small hole; from bottom surface, of the top plate. An anchor bolt is normally straight and conjoins two surfaces. This invention purposes each anchor bolt to be angled; at 90°, forming an “L” shape. Its' machine thread-end is screwed through the small hole; to be flush with, the upper surface; FIG. 2, no. 6. The flat end is a visual marker; to be seen as a “dot”, on the upper surface. Each dot shows the anchor bolts' relative position to the access portal and key-way.

The inner curvature, FIG. 2, no. 5; within the anchor bolts' 90° angle; FIG. 2, no. 6b, functions as a “stop-catch area” for vertical alignment hardware, that is attached to the lower area of the primary annular member at FIG. 2, no. 1. The spiraling threads; at FIG. 2, no. 6a, provide a non-slip-grip under the vertical alignment hardware, to press it's surface against the lower surface of the top plate. The bottom plates' surface augment's a slight, upper pressure, against the bottom surface of the vertical embodiment, thus transferring upper pressure against the alignment hardware, to hold it against the top plates' lower surface.

Such combined pressures of the spiraling threads, at FIG. 2, no. 6a, with the bottom plate; FIG. 2, no. 10, induce a firm, holding pressure under the vertical alignment eye bolt; FIG. 2, no. 5, to be pressed against the bottom surface of the top plate; FIG. 2, no. 8, to keep the primary member; FIG. 2, no. 1, in a very secured vertical posture.

### Primary Annular Device

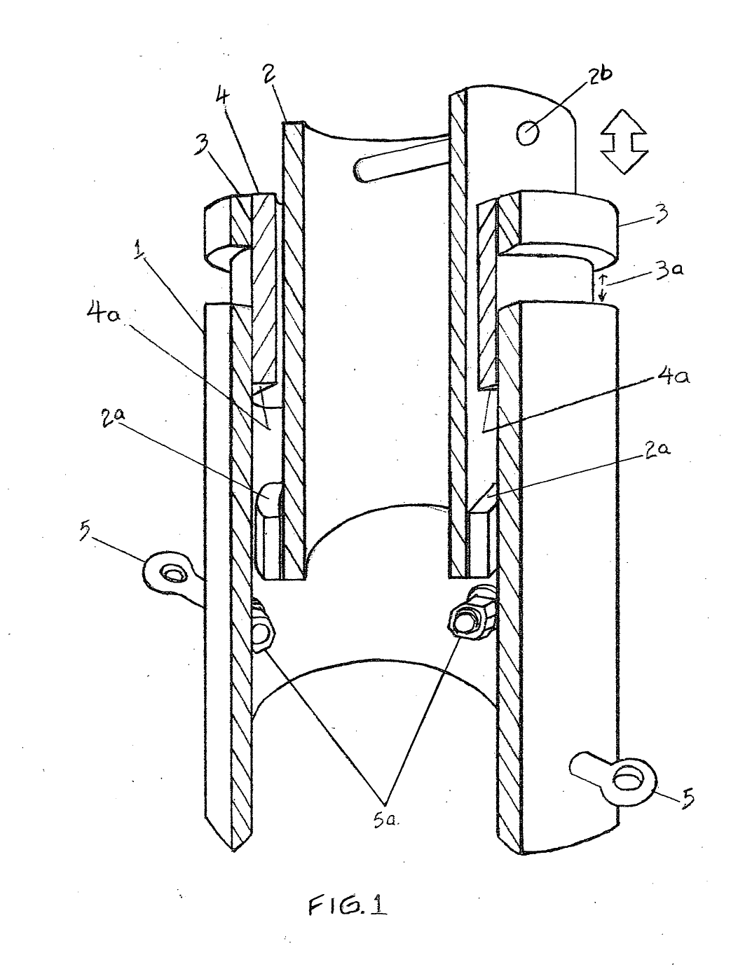

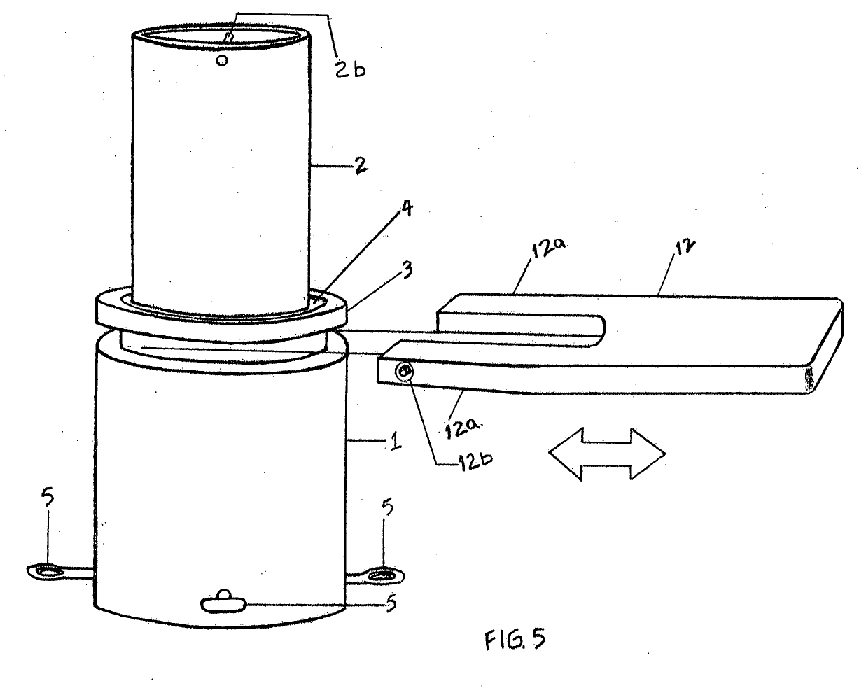

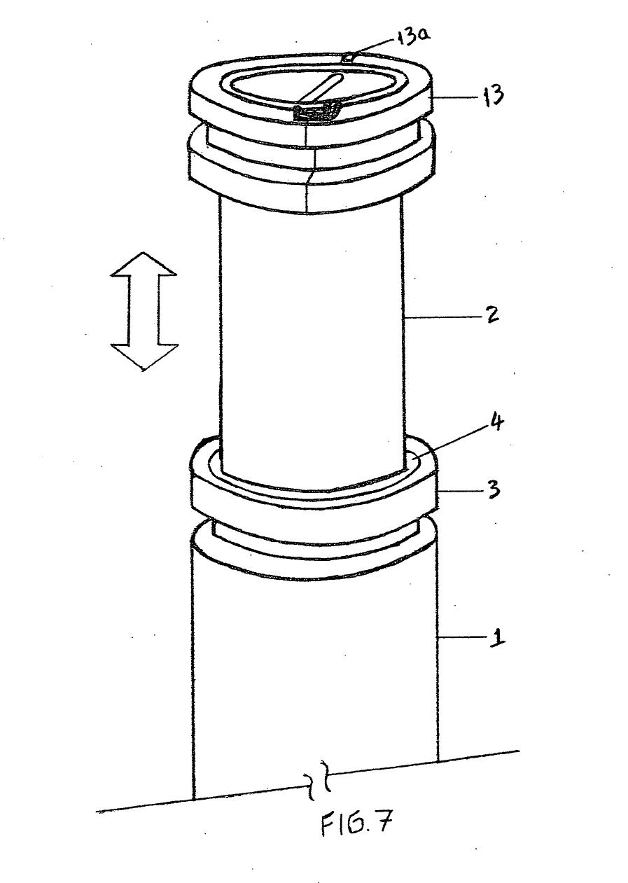

The primary annular device is also named a primary annular member, primary member, and first linear annular device; FIG. 2, no. 1. Its core is hollow as FIG. 1 exhibits. Its' exterior, vertical surface; FIG. 1, no. 1, enables any type of replaceable, fibrous material to be held up-right for feral felines, domestic felines and small animals to claw it, climb it, and stretch against it. The primary member has an exterior; integral member, at its' upper most area known as the open channel area, FIG. 1, no. 3a. This area receives a modular flat embodiment; FIG. 5, no. 12, and positions it in a horizontal plane; FIG. 7a, no. 12c, that is parallel to the ground. Such flat embodiment can swivel within the open channel in 360°, around the primary member.

FIG. 5, no. 1, depicts a profile perspective view, of the primary annular member and its' vertical alignment eye bolt no. 5, near its lower area. FIG. 3 depicts the primary annular member in a static position while the secondary annular member; at no. 2, is in a stowed; un-telescoped, position. FIG. 1 shows a 3-D profile perspective view of the primary annular member. Hash marks indicate it is opened, to see its inner area. Several vertical alignment eye-bolts; at no. 5, are inserted through the wall and extend into the hollow area. A nut with washer; no. 5a, are tightened to the vertical alignment eye bolts' threaded end. This hardware is secured in the foundational enclosures' hollow chamber by anchor bolts' stop-catch area and gripping threads; at FIG. 2, nos. 6a&b, that are affixed to the underneath surface of the top plate.

### Integral Open Channel Area

A ring; FIG. 3, no. 3, distinguishes the upper area of the primary member. Its' inner-diameter surface is bonded; via cementing adhesive, to the coupler's upper; outer surface, at no. 4. The lower surface of the ring; below no. 3, becomes the upper surface of the open channel area. The lower; horizontal surface, of the ring partners with the flat surface of the primary members' upper end, to provide two surfaces that hold the upper and lower surfaces of the modular ledge in a horizontal position. FIG. 1, no. 4a, shows the lower surface of a coupler is inserted within the primary annular member's upper cavity area.

The couplers' inner; vertical surface, is a stabilizing shim that renders horizontal stability for the secondary member, when it is being pulled up to any elevation. The couplers' exterior, radius surface; within the open channel area; FIG. 1, no. 3, guides the modular ledges'; pronged forks inner radius, around a 360° horizontal plane, about the primary members vertical axis. The couplers' interior surface is a triple-action functioning shim, for the secondary member. The shim enables the secondary member to move up and down smoothly; within the primary member's cavity, while simultaneously giving horizontal stability to the secondary member when ascending and descending. The couplers' lower surface acts as a stop-surface against the secondary annular members' lower shim; at no. 2a, by preventing the secondary member from coming out of the primary member's cavity.

### Materials for Primary and Secondary Members

The primary and secondary annular members can be of aluminum, cement, wood, composites, poly resins such as PVC and ABS. ABS possesses an outstanding resistance to impacts, thus, confirming its strength for consumer products and superior dimensional stability.

### Secondary Annular Member

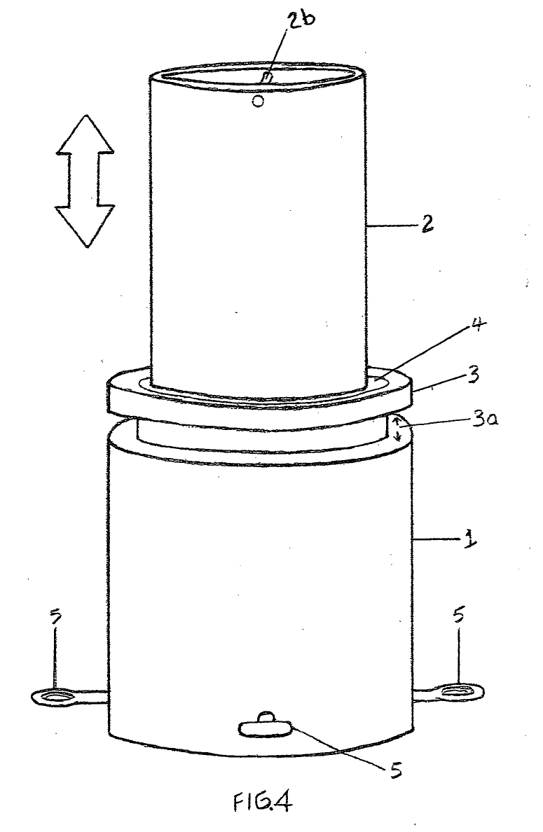

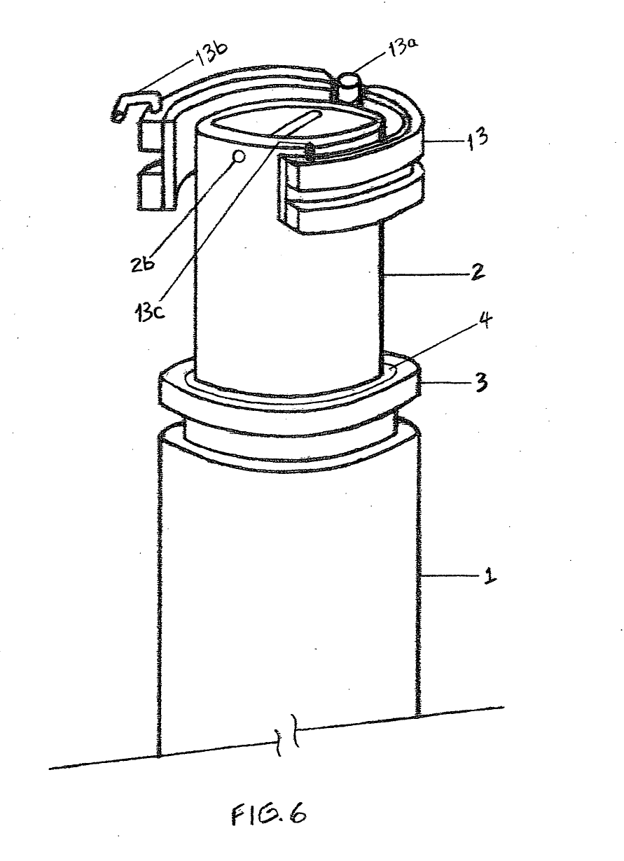

The secondary annular device; FIG. 1, no. 2, is an integral member within the primary members' hollow core. This secondary annular device is also named a secondary annular member, secondary member, and second linear annular device, FIG. 3, no. 2 depicts the secondary annular member in a stowed position within the primary annular member. FIG. 4, no. 2 depicts it in a fully telescoped position. No. 2b is the horizontal handle; near the secondary members' upper edge. It is pulled up to any elevation including full extension. When the secondary member is; manually telescoped up, to any elevation, a modular, hinged open-channel collar; FIG. 6, no. 13, can be placed anywhere on the secondary members' surface.

This modular collar supports a modular flat embodiment; FIG. 7a, no. 12e, similar to the way the integral open-channel area functions, atop the primary member; FIG. 7a, no. 12c. FIG. 5, no. 2 depicts the secondary annular member telescoped. No. 2b shows the horizontal handle, used to pull the secondary member up. Such handle has vertical surfaces on each end that can rest within; opposing circular thru-holes of the secondary member upper wall; 180° degrees apart. Both ends of the rod shaped handle fit snugly within their respective hole, so there's no sideways slip-page nor can the roundness of the rod be turned about its longitudinal axis; within the holes inner diameter area. If inserting both ends of the handle; within holes, isn't done, both ends can be affixed within the inner hollow area; snugly between the vertical walls by a cementing adhesive. The handle can be made of wood, metal, aluminum and any composite material.

### Secondary Members' Shims

FIG. 1, no. 2a, depicts the secondary annular members' lower shim. Four (4) shims are positioned at 90° degree intervals; apart and around its outer wall, near its bottom edge. Each shim's inner surface is concaved, to conform to the secondary members' outer wall's surface curvature. Both surfaces are bonded together with a cementing adhesive.

The outer surface of each shim, rubs against the inner walls' surface of the primary annular member, to stabilize any jostling motion, when the secondary member is being pulled up through the primary members' hollow area. When the secondary annular member is at its highest; upward extension, its lower shims' upper surface; at 2a, makes contact with the couplers' bottom surface at no. 4a. There is more than sufficient; lower area of the secondary annular member remaining; within and under the coupler, within the secondary annular members' cavity, to provide a horizontal stability to the embodiment extending up at any elevation. Such stability can support the embodiment when it is at its fullest upward extension.

### Modular Ledge

For the purpose of this writing, the modular ledge is rectangular shaped. Its shape and length can vary. One end is a two pronged-fork, while the opposite end has a vertical edge. The two-pronged fork end; FIG. 5, no. 12a, is manually inserted into the open channel collar, in FIG. 7a, no. 12c, at the upper area of the primary member. After the prongs are inserted, a strap with concaved or female metal snap fasteners; near each end, FIG. 7a, no. 12d covers its' male counterpart; on the outer surface; near each pronged end, within the open channel collar.

The strap body length is positioned longitudinally; within the collars open channel area, and each female snap is fitted onto its' male receptor; FIG. 7a, no. 12b, that is positioned on the vertical side surface of a prong. The strap holds the prong end into the open channel firmly, so the ledge can be manually rotated about a horizontal plane in 360° degrees around the primary annular member. The ledges' length can be made long enough for its' outer edge touches within the space of the open channel collar; of an adjacent primary annular member. The open channel collar can support the ledges' end; in a horizontal plane, thus a bridge is formed between two primary annular members when a foundational enclosure provides multiple access portals.

The modular flat ledge can function to support another enclosure, such as a condo or other enclosure on its upper surface, thus, this inventions' ledge functions in two ways. (Not shown in artwork) Such ledge can be any width and length, so long as its thickness conforms to being inserted into the open channel area of the collar.

### Modular Hinged Open Channel Collar

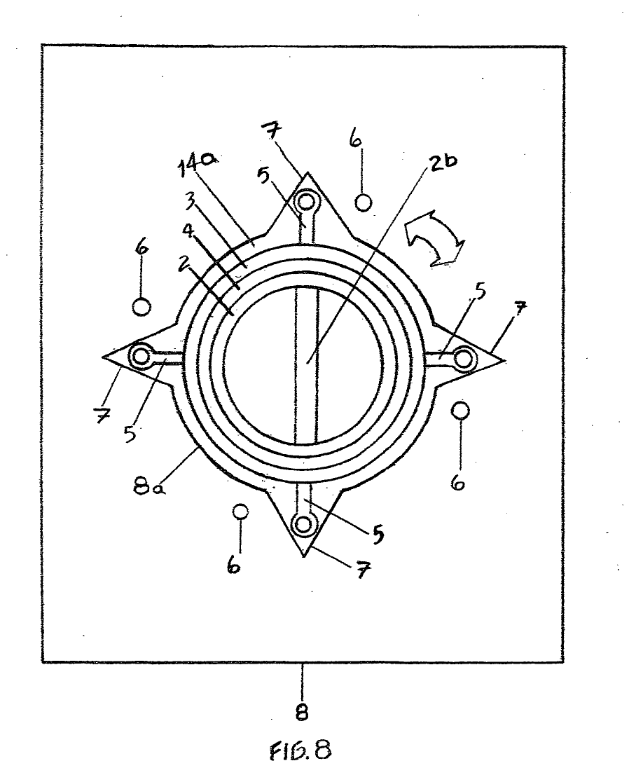

Surfaces within the modular, hinged, open-channel collar are smooth, requiring no sanding and no machining. When the prong's inner curvature's vertical surface; FIG. 5, no. 12e, make contact with the open channels' inner wall; having a vertical surface, movement about the horizontal plane produces no friction or friction is minimal. FIG. 9 depicts the modular open channel hinged collar in a closed position but, not latched. No. 13a depicts its two hinges that are placed in-line with the outer surface of both ringed members.

Both hinges can be affixed in position with cementing adhesive or other small hardware. No. 13 depicts both ringed members as no. 13d depicts the coupler that is affixed; with cementing adhesive, to the inside diameter of both ringed members vertical surfaces. No. 13e depicts the open channel area where a ledge is inserted. No. 13b depicts the latch and no. 13c depicts the pin. The latch is manually pivoted around to hold the pin and as the end of the latch clasps around the pin, this defines the “locking mechanism”.

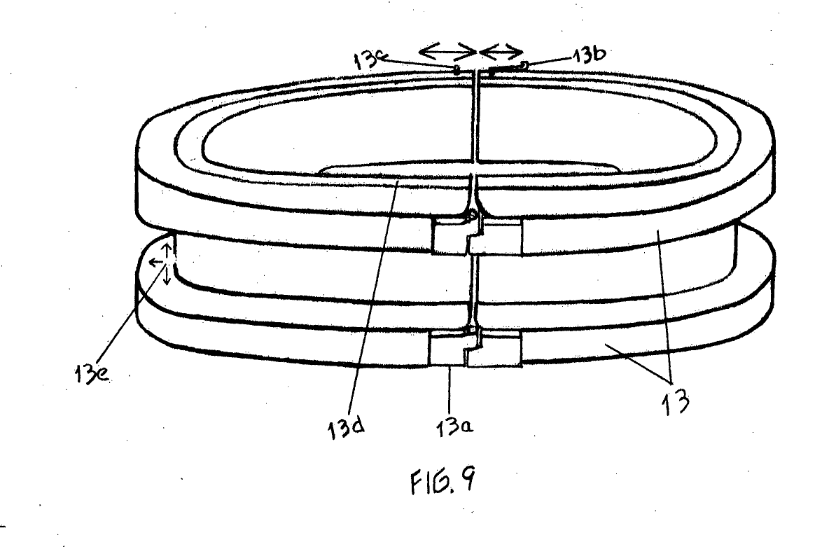

A plan view depicts the back surface of the modular open channel collar when it is fully opened as seen in FIG. 10. No. 13 depicts the flat, vertical surfaces of the ringed member ends. No. 13a depicts back surfaces of the hinges. No. 13d depicts the inner surface area of the coupler; in a half-shell appearance.

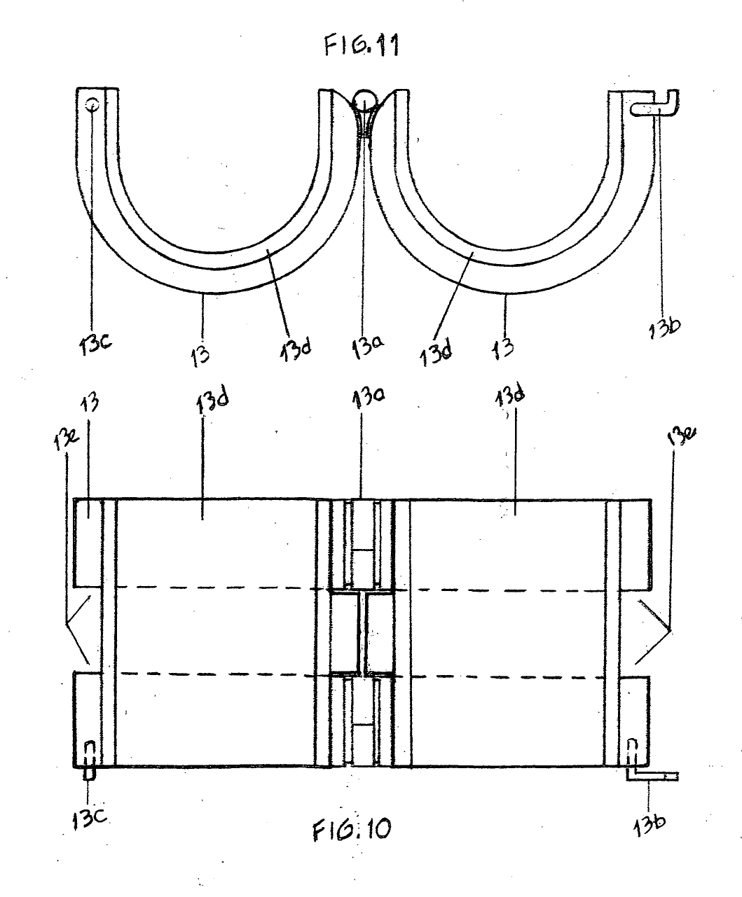

Another plan view; FIG. 11 depicts the modular open channel collar is fully open and resting on the lower surfaces of two halves; of ringed members no. 13 and two half-shells of the coupler, no. 13d. No. 13a depicts the hinge. No. 13b depicts the latch. From a left-to-right orientation, no. 13c depicts the latching pin pointing up. No. 13 depicts the upper surface of half a ringed member. No. 13d depicts the upper flat surface of the coupler.

Carpet or any fibrous material covering each ledge can be removed, turned over, and refitted onto the ledge, thus each fibrous material is specially formed for the ledge to have two useable surfaces.

It should be noted that the spirit and scope of this invention should not be taken in a limiting sense, as such embodiments selected for illustrating the details are made merely for the purpose of illustrating the general principles of the invention.

REFERENCED BY

| Cited Patent | Filing Date | Publication Date | Applicant | Title |
|---|---|---|---|---|
| U.S. Pat. No. 2,005,817* | Jan. 29, 1934 | Jun. 25, 1935 | Daniel D. Yoder | Scratching Post |
| U.S. Pat. No. 2,894,487* | Sep. 21, 1956 | Jul. 14, 1959 | Marvin Goldson | Scratch post with renewable |
| | | | | fabric cover |
| U.S. Pat. No. 2,997,019* | Dec. 31, 1959 | Aug. 22, 1961 | John H. Bryson | Cat's claw filing post |
| U.S. Pat. No. 3,479,990* | Jan. 11, 1968 | Nov. 25, 1969 | Frank L. Crow | Cat Tree |
| U.S. Pat. No. 3,479,991* | Jul. 10, 1968 | Nov. 25, 1969 | William J. Lichtenberger | Animal climbing structure |
| U.S. Pat. No. 3,595,209* | Jan. 28, 1969 | Jul. 27, 1971 | Paul A. Parker | Household play and exercise |
| | | | | post assembly for cats |
| U.S. Pat. No. 3,993,027 | Mar. 6, 1975 | Nov. 23, 1976 | Donald A. | Cat scratching post |
| | | | Mullin-Lawrence | |
| | | | Peska Associates, Inc. | |
| U.S. Pat. No. 5,884,586 | May 8, 1997 | Mar. 23, 1999 | Antonio F. Carbonelli | Interchangeable cat house |
| U.S. Pat. No. 4,177,763* | Apr. 17, 1978 | Dec. 11, 1979 | Weldon R. Cook | Cat scratching post assembly |
| U.S. Pat. No. 4,253,423 | Jun. 26, 1979 | Mar. 3, 1981 | Michael L. Kaplan | Cat scratching and climbing post |
| U.S. Pat. No. 5,054,429 | Oct. 13, 1989 | Oct. 8, 1991 | Collins C. Bradford | Cat scratching post and method for |
| | | | | making a cat scratching post |
| US-2002/0179021A1 | May 31, 2001 | Dec. 5, 2002 | Deraspe-Bolles Monica | Reconfigurable modular play and |
| | | | and Moore Barry G. | exercise structure for animals |
| U.S. Pat. No. 5,144,911* | Nov. 28, 1990 | Sep. 8, 1992 | Cheri L. Moore/ | Component bed system for a pet |
| | | | Judy L. Ha | |
| U.S. Pat. No. 5,176,105* | Aug. 2, 1991 | Jan. 5, 1993 | Marc. P. Madden | Fur grooming apparatus |
| U.S. Pat. No. 5,517,945* | Dec. 30, 1994 | May 21, 1996 | Steven D. Udelle | Combined mechanically |
| | | | | assisted animal amusement, |
| | | | | grooming, and claw scratching device |
| U.S. Pat. No. 5,577,466* | Sep. 7, 1994 | Nov. 26, 1996 | Pamela M. Luxford | Modular play structure for animals |
| U.S. Pat. No. 5,628,282* | Apr. 1, 1996 | May 13, 1997 | Steven D. Udelle | Mechanically assisted animal |
| | | | | self-grooming device |
| U.S. Pat. No. 5,680,831* | Feb. 20, 1996 | Oct. 28, 1997 | Steven D. Udelle | Combined mechanically assisted |
| | | | | animal exercise, amusement, self |
| | | | | grooming, and claw |
| | | | | scratching stimulator |
| U.S. Pat. No. 5,713,306* | Sep. 26, 1995 | Feb. 3, 1998 | Arnold B. Johnson | Feline playground system |
| U.S. Pat. No. 5,875,735* | Dec. 20, 1996 | Mar. 2, 1999 | Joseph E. Bradley | Modular animal perch attached to wall |
| U.S. Pat. No. 6,619,237* | Jun. 18, 2002 | Sep. 16, 2003 | Nita J. Robertson | Recoverable cat-scratching post |
| US-2004/0194731* | Mar. 5, 2004 | Oct. 7, 2004 | Christopher J Lineberry | Decorative scratching post |
| U.S. Pat. No. 6,966,277* | Apr. 21, 2003 | Nov. 22, 2005 | Monica DeRaspe-Bolles- | Reconfigurable modular play and |
| | | | Epoch Design, Llc | exercise structure for animals |
| US-2005/0263096* | May 12, 2004 | Dec. 1, 2005 | Frank P. Mita | Pet furniture system |
| U.S. Pat. No. 7,171,922* | May 30, 2004 | Feb. 6, 2007 | John M. | Cat scratching post |
| | | | Lipscomb-G.H.L. | |
| | | | International, Inc | |
| U.S. Pat. No. 7,207,293* | Jun. 9, 2004 | Apr. 24, 2007 | Robert F. Deming, Jr. | Protective cat scratching post |
| US-2008/0282987* | May 17, 2007 | Nov. 20, 2008 | Sharon A. Ritchey | Cat tower with separable transportable |
| | | | | bed, inset corrugated scratch pad/fabric |
| | | | | base, and washable woven fabric covers |
| US-2008/0216763 | Mar. 9, 2007 | Sep. 11, 2008 | Michael A. Ebert | Scratching Device |
| U.S. Pat. No. 7,770,540* | Dec. 21, 2006 | Aug. 10, 2010 | Eric Lee Halpem- | Exercise and perch system for |
| | | | Design Werks, Inc. | domestic cats |
| U.S. Pat. No. 7,867,143* | Apr. 22, 2005 | Jan. 11, 2011 | Jens Fenger-Eriksen | Climbing tree |

*Cited by examiner
CLASSIFICATIONS

| | |
|---|---|
| U.S. Classification | 119/706, 119/28.5, 119/622, 119/608, 119/609, 428/35 |

LEGAL EVENTS

| Date | Code | Event | Description |
|---|---|---|---|
| Feb. 3, 2006 | FP | Expired due to failure | Effective Date |
| | | to pay maintenance fee | Mar. 8, 2006 |
| Feb. 3, 2005 | FP | Fee Payment | Year of fee payment: 8 |
| Aug. 2, 2001 | FP | Fee Payment | Year of fee payment: 4 |

1. This telescoping claw post assembly is covered with carpet sections and rope-formed sections backed with hook and loop strips; along the sides, enabling self-closure around each unit of assembly for feline(s) and small animals to claw-up and use, and when any section of covering is unusable that section is removed and a new cover is either wrapped around, slid over, or laid on top of that unit, wherein the entire assembly is comprised of: a foundational base enclosure that holds one or more hollow, rigid, large-diameter tubular structures up-right; from within the en-closure, and each large-diameter tube has a shallow, open-channel; near its' upper end, that is open in 360° for receiving the pronged-end; of a modular flat ledge, to be held level with the ground, and each large-diameter tube also has a small-diameter concentric tube within its' core, to remain un-telescoped and unseen, or be telescoped up incrementally-to-its' fullest height, after which, a modular open-channel collar is placed around any sufficiently available vertical surface; covered or not, for its' open-channel receives the pronged-end of a modular flat ledge, to hold the ledges' length level with the ground, in a static position or be moved to any position within a 360° horizontal radius.

2. The foundational base enclosure in claim 1, is a shallow, rectangular box-like enclosure and is also a square, oval, octagon, multi-level or other shaped enclosure having a top, bottom, and side plates.

3. The top plate in claim 2, has one and multiple large-circular thru-holes; approximately adjacent to each other, where each is a reference center, having its' curved edge open; every 90° degrees or so, at the widest span of an isosceles obtuse triangular shaped through-hole; a key-way, and a smaller-diameter circular through-hole is off-set from the right edges of the large-diameter and triangular shaped thru-holes.

4. A small-diameter circular thru-hole in claim 3, having an anchor bolts' machine-thread screwed up into its' through-hole; at the lower surface, until its' flat end is flush with the upper surface and a very short length of machine-threads extend out of the bottom of through-hole before bending; 90°, where machine threads change, to be more open and spiraling threads to parallel the lower surface and a space is evident above the threads and below the lower surface.

5. The anchor bolts' loosely spiraling threads according to claim 4, holds positive pressure under each vertical alignment eye-bolt shaft, to be against the lower surface of top plate, therein holding the large-diameter tube up-right within the base enclosure.

6. The large-diameter tube in claim 1, is hollow, having a rigid-dense wall that is sufficiently tall to negate tipping the base enclosure over when weight is added to its' highest elevation and such large-tube is held in a vertical position Prior-To manually telescoping the smaller-diameter concentric tube within.

7. The large-diameter tube is hollow, having a rigid-dense wall that is sufficiently tall according to claim 6, that its' lower area; near its' end, is anchored with numerous vertical alignment eye-bolts, fanning out-ward and perpendicular with its' surface.

8. The large-diameter tube having numerous vertical alignment eye-bolts fanning out-ward from the tubes' surface and perpendicular to surface according to claim 7, is a nut and washer holding the threaded end; of the eye-bolt shaft, against the inner tubular wall and thru the walls' hole to the outside, where the remaining length of shaft and eye are ready to be held between the anchor bolt and lower surface of top plate.

9. The large-diameter tube having numerous vertical alignment eye-bolts fanning out-ward from around its' surface according to claim 8, has a small-diameter concentric tube within; for telescoping up, and the total combined height of the small-diameter tube; when fully telescoped up, with the large-diameter tube will not over-turn the foundational base enclosure when weight is added to upper elevations.

10. The small-diameter concentric tube according to claim 9, is un-telescoped and telescoped within the large-diameter tube; via an internal coupler, and after being telescoped to a height of sufficient elevation, such large-diameter tube and telescoped tube is covered with a section of carpet or a roped-section and the telescoped tube can remain uncovered for one or multiple modular, hinged, open-channel collars can encapsulate any available vertical section of surface; covered or not, on the small-diameter tube.

11. The small-diameter concentric tube in claim 10, has multiple shims affixed to its' exterior surface, as each is positioned around and near the lower end, for when in a static position each shims' outer surface touches the inner wall of large-diameter tube; for lateral stability, and all shims rub against the wall simultaneously, during any movement for dynamic lateral stability.

12. The small-diameter concentric tube in claim 11, having multiple shims affixed to its' lower exterior area, each shim's lower surface touches the upper surface of a nut; upon maximum descent, to stop its' descent and each nut holds a washer in a tightening manner on the threaded end of the eye-bolts' shaft; through the wall, thus holding the large-diameter tube in a tight grip.

13. The modular, hinged, open-channel collar in claim 1, surrounds a vertical section of the small-diameter concentric tube; covered or not, with a snug grip, as the collar securely supports a modular ledge in a level position.

14. The internal coupler within the large-diameter tube in claim 10, is a rigid, hollow, concentric device having uniform parallel side-walls with a flat; upper and lower surface, wherein its' upper area is covered by one concentric ring; having two flat surfaces, wherein the rings' upper surface is flush with the couplers' upper surface.

15. The coupler with a ring according to claim 14, defines 3 features . . . 1st: A flushness of two upper surfaces establish a new upper-end for the large-diameter tube, and 2nd: An exterior space exists; as a shallow open-channel, between the couplers' ring and top edge of large tube; when the coupler has been lowered within, and the 3rd: the couplers' bottom flat surface is a stop surface, limiting the small-diameter tubes' maximum ascent.

16. The Modular, Hinged, Open-Channel Collar in claim 13, is a rigid, short-in-height pair of half-shells; with half-rings on both tops and bottoms, and one set of half-shell-sides are conjoined by two sets of hinge-plates; above each other on opposite ring surfaces, and as the pair of half-shells pivot; about hinge-pins, their outer-ends touch and a stiff wire a-top one half-shell; near its' end, pivots horizontally for its' curved end grips the pin; on opposite half-shell, to hold both half-shells together.

17. The Modular, Hinged, Open-Channel Collar in claim 16, is a rigid, short-in-height pair of half-shells; with half-rings on both tops and bottoms, for when both half-shell-ends touch, a 360° open channel exists, and such vertical space closely equals the vertical thickness of a modular ledge.

18. The Modular, Hinged, Open-Channel Collar in claim 17, is a pair of half-shells held together by multiple hinges and a stiff wire, resulting in a 360° horizontal open channel of space; between two rings, and such space permits the insertion and adjustment of the pronged-end of a modular ledge.

19. The modular, hinged, open-channel collar in claim 18, allows a snug fit of pronged-ends; of a modular ledge, and such pronged-ends have an inner-radius that rub against the open-channels' inner; convexed-curved, wall.

20. The pronged-end of a modular ledge according to claims 1 and 19, is held within the open-channel of modular, hinged, collar and within the open-channel of the large-diameter tube by a semi-stiff, thin, narrow strap, having a female connector on both ends, that snap over a male receptor; affixed to outer sides of both pronged-ends, for the strap holds the modular ledges' inner-curved surface against both channels' inner; convexed-curved, wall.
